(19) United States
(12) Patent Application Publication
(10) Pub. No.: US 2014/0228491 A1
(43) Pub. Date: Aug. 14, 2014

(54) INJECTION MOLDING MEANS

(71) Applicant: GINAR TECHNOLOGY CO., LTD, Taoyuan County (TW)

(72) Inventors: Yuan-Chen Chern, Taoyuan County (TW); Chun-Chung Chung, Taoyuan County (TW)

(73) Assignee: GINAR TECHNOLOGY CO., LTD, Taoyuan County (TW)

(21) Appl. No.: 14/259,379

(22) Filed: Apr. 23, 2014

Related U.S. Application Data
(63) Continuation of application No. 13/585,087, filed on Aug. 14, 2012.

(51) Int. Cl. C08L 69/00

(52) U.S. Cl. CPC C08L 69/00
USPC 524/127; 524/502; 524/612; 524/140; 524/115; 524/157

(57) ABSTRACT

An injection molded body including a mixture of aromatic polycarbonate, profiled glass fiber (PGF), a flame retardant and a functional additive. The profiled glass fiber is a high profile ratio glass fiber (flat glass fiber). With the use of aromatic polycarbonate and PGF for thin-wall injection molding, high melt index (Melt Index, MI) of above 30 g/10 min and high flexural modulus of above 6 GPa in the case of low glass fiber proportion (20-35%), and high Melting Index value of above 50 g/10 min and high flexural modulus of above 11 GPa in the case of high glass fiber proportion (40-50%) can be reached.

### RELATED APPLICATIONS

This application is a continuation of U.S. application Ser. No. 13/585,087 filed Aug. 14, 2012 and entitled “Injection Molding Means”.

### BACKGROUND OF THE INVENTION

1. Field of the Invention

Embodiments relate to an injection molded body which uses aromatic polycarbonate and profiled glass fiber (PGF) as main materials and facilitates injection moldings with high Melting Index values of above 50 g/10 min (5 kg/260° C.) and high flexural modulus of above 11 GPa in the case of high glass fiber proportion (40-50%). Such moldings can be applied to the use of injection molding processing for netbooks and ultrabooks and thin tablets. The injection moldings formed with the disclosed injection processing achieve less floating fibers and have the effects of low warpage and high stiffness.

2. Description of Related Art

In recent years, electronic equipment such as mobile phones, portable game consoles, personal digital assistants (PDAs), Tablet PCs (Tablets), NetBooks and ultra-thin laptops (UltraBooks) has increasingly high demand to be thin and lightweight. In response to this demand, external appearance or interior components of the above electronic equipment manufactured with the use of injection molding must be thin and have high stiffness. During injection molding in an injection molding machine, high stiffness, thin-wall molding and dimensional stability are required at conditions of high injection pressure, high injection speed and low molding temperature.

Aromatic polycarbonates have properties of excellent heat resistance and good impact properties and have therefore been widely used as material for the external or interior components of products such as tablets, desktop and notebook computers, and business machines such as printers, copiers and fax machines.

Recently, molded products formed by aromatic polycarbonates, particularly those for tablets, netbooks or ultra-thin laptops, have been put into practice of ultra-thin dimension in response to the requirements for light weight. However, there is a tendency to deform due to external stress or distortion due to the thin-wall of the cover appearance for the tablets, netbooks or ultra-thin laptops. Therefore, a need exists to improve the stiffness and dimensional stability for aromatic polycarbonates.

Attempts have been made to use reinforcing materials and fillers, and add inorganic compounds such as glass fiber, carbon fiber, talc, mica and calcium silicate to polycarbonate to improve the stiffness and dimensional stability for aromatic polycarbonates.

Amorphous co-rubber blending resins such as aromatic polycarbonates or aromatic polycarbonate/acrylonitrile butadiene styrene (e.g. acrylonitrile Butadiene Styrene, ABS) copolymers have high dimensional stability or high toughness, but low flowability. If a fibrous reinforcing material of high aspect ratio is added, then the flowability will be further reduced and formability is going to worsen. It has been that the fibrous reinforcing material has a filling limit of about 20 wt %, which is hard to cooperate with the amorphous resin to achieve thin moldings having high stiffness, less floating fiber and low warpage. Therefore, the prior art cannot meet the needs for users in practical use.

### SUMMARY OF THE INVENTION

Embodiments aim at overcoming shortcomings in the prior art of thin-wall injection molding, and providing an injection molded body which uses aromatic polycarbonate and profiled glass fiber (PGF) as main materials for thin-wall injection molding so that a high melt index (Melt Index, MI) of above 30 g/10 min (1.2 kg/300° C.) and high flexural modulus of above 6 GPa in the case of low glass fiber proportion (20-35%), and high MI value of above 50 g/10 min (5 kg/260° C.) and high flexural modulus of ABOVE 11 GPa in the case of high glass fiber proportion (40-50%) can be reached. This can be applied to the use of injection molding processing for tablets, netbooks or ultra-thin laptops. The injection moldings after the disclosed injection processing achieve less floating fibers and have the effects of low warpage and high stiffness.

In order to achieve the above and other objectives, the injection molded body is formed in an injection mold having a cavity and an injecting port connected to the cavity and the injection molded body is located inside the cavity of the injection mold and injected from the injecting port. The injection molded body includes a mixture of aromatic polycarbonate, profiled glass fiber (PGF), a flame retardant and a functional additive. The profiled glass fiber is a high profile ratio glass fiber (flat glass fiber). The amount of aromatic polycarbonate is 30-50 wt %; the amount of profiled glass fiber is 20-50 wt %; the amount of the flame retardant is 9-15 wt %; and the amount of the functional additive is 1-9 wt %

In one of the embodiments, the injection mold includes a female mold and a male mold which are placed in opposite to each other to form the cavity.

In one of the embodiments, aromatic polycarbonate is a thermoplastic resin, and can be also selected from a composition including aromatic polycarbonate/acrylonitrile butadiene styrene (ABS) alloy.

In one of the embodiments, the profiled glass fiber has a profile ratio between 1.5-6 and an aspect ratio between 15-300, and can be mixed with at least one of low aspect ratio filling materials of glass powders, calcium silicates, calcium carbonates, nano clays, nano-silicon, talc, etc.

In one of the embodiments, the flame retardant is a phosphorus flame retardant, and can be selected from organic phosphates and/or organic compounds containing a phosphorus-nitrogen bonding, such as aromatic phosphates of (GO)3P=0, wherein each G is independently alkyl, cycloalkyl, aryl, alkyl aryl or aralkyl. Two of the G groups can be linked together to provide a ring group such as di-phosphoric acid DIPHENYL pentaerythritol. In addition, other suitable aromatic phosphates can be diphenyl pentaerythritol diphosphate, phenyl di-(dodecyl) phosphate, phenyl di-(neopentyl) phosphate, phenyl bis-(3,5,5′-ethylhexyl) phosphate, ethyl diphenyl phosphate, 2-ethylhexyl bis-(p-tolyl) phosphate, bis-(2-ethyl hexyl) toluene phosphate, mesitylene phosphate, bis-(2-ethylhexyl) phenyl phosphate, tris (nonyl phenyl) phosphate, di-(dodecyl) toluene phosphate, dibutyl phenyl phosphate, 2-chloro-ethyl diphenyl phosphate tolyl, bis-(2,5,5′-trimethyl-hexyl) phosphate, and 2-chloroethyl hexyl diphenyl phosphate and the like.

In one of the embodiments, the flame retardant is an inorganic flame retardant, and can be selected from potassium perfluorobutane sulfonate (potassium nonafluoro-1-butane-sulfonates, or referred to as Rimar salts) or sulfonic acids such as potassium diphenyl sulfonate.

In one of the embodiments, the functional additive includes a composition of at least one selected from siloxane coupling agents, polyethylene terephthalate (PET), acrylonitrile styrene (AS), acrylonitrile-EPDM rubber-Styrene copolymer (Acrylonitrile Ethylenepropylene Styrene, AES), styrene acrylonitrile silicone (SAS), acrylonitrile styrene acrylate (ASA), polyvinylidene fluoride or poly-vinylidene difluoride (PVDF), and polytetrafluoroethylene (PTFE). The siloxane coupling agents contain different functional groups of hydroxyl, epoxy, carboxyl, and amino etc.

In the above embodiment, the injection molded body can further include a dispersing auxiliary. The dispersing auxiliary includes aliphatic wax or phosphorus compounds and can be selected from organic phosphorus compounds of phosphate compounds, phosphite compounds and phosphinate compounds.

In one of the embodiments, the injection molded body further comprises a dispersing auxiliary which includes aliphatic wax or phosphorus compounds and can be selected from organic phosphorus compounds of phosphate compounds, phosphite compounds and phosphinate.

### BRIEF DESCRIPTION OF THE DRAWINGS

FIG. 1 is a schematic view of an appearance of an injection mold and molded body according to one embodiment.

FIG. 2 is a schematic, exploded view of an injection mold according to one embodiment.

FIG. 3 is a schematic view of in-use status of an injection mold according to one embodiment.

### DETAILED DESCRIPTION OF THE PREFERRED EMBODIMENTS

The aforementioned illustrations and following detailed descriptions are exemplary for the purpose of further explaining the scope of embodiments of the invention. Other objectives and advantages related to the embodiments will be illustrated in the subsequent descriptions and appended tables.

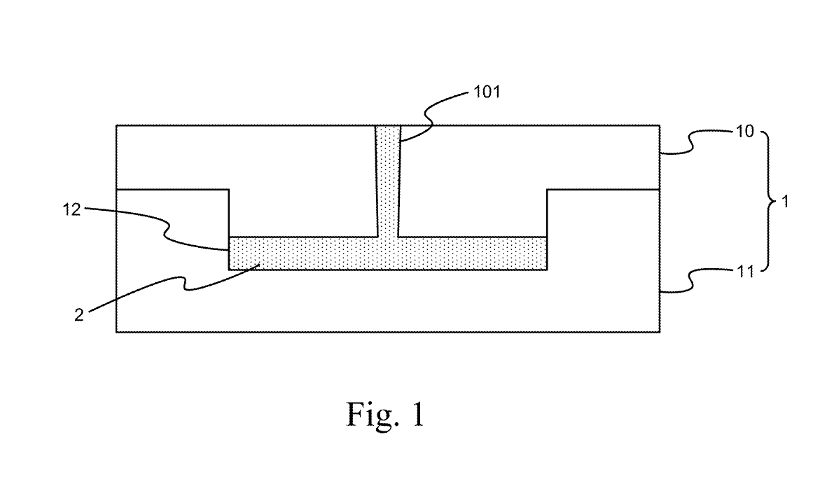

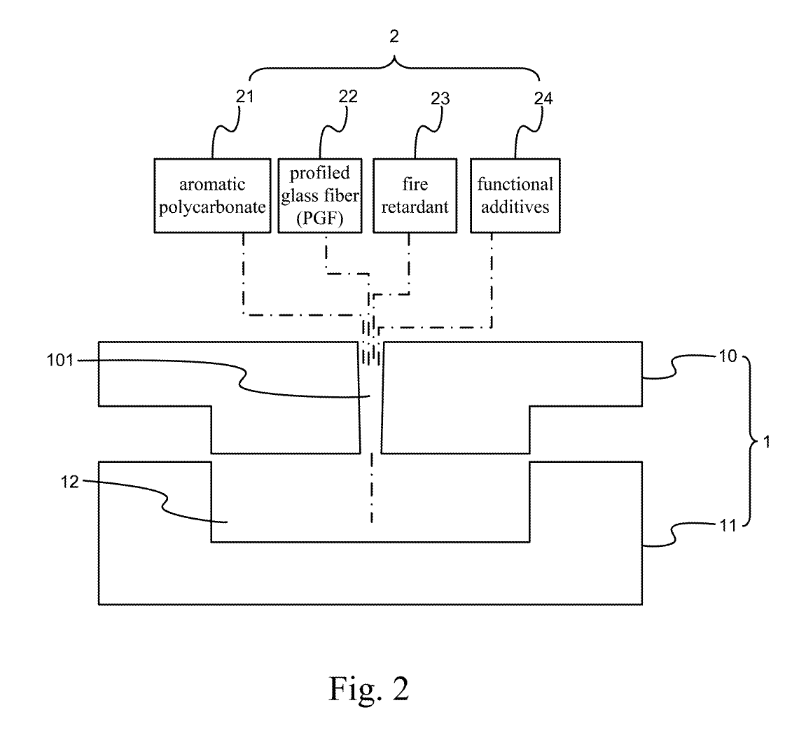

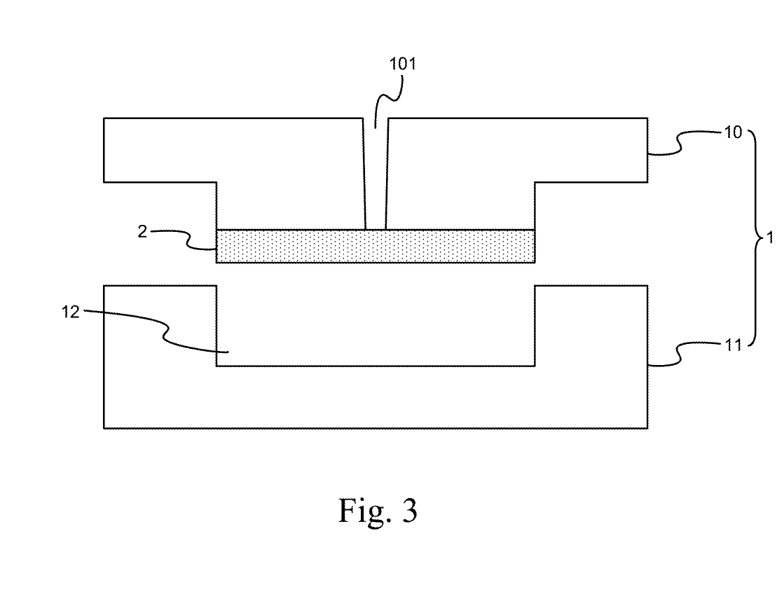

FIG. 1 is a schematic view of an appearance of an injection mold according to one embodiment. FIG. 2 is a schematic, exploded view of an injection mold according to one embodiment. FIG. 3 is a schematic view of in-use status of an injection molded body according to one embodiment. As shown, the injection mold of one embodiment at least includes an in injection mold 1 and an injection molded body 2.

The injection mold 1 includes a male mold 10 and a female mold 11. The female mold 11 and the male mold 10 are placed in opposite to each other to form a cavity 12. The male mold 10 has an injecting port 101 connected to the cavity 12. The injection mold 1 described here below is an example in one embodiment. The male mold 10 and the female mold 11 can be, but not limited to, what is described in the embodiments.

The injection molded body 2 is located inside the cavity 12 of the injection mold 1 and is injected from the injecting port 101. The injection molded body 2 contains a mixture of aromatic polycarbonate 21, profiled glass fiber (PGF) 22, flame retardant 23 and functional additives 24. When the content of PGF 22 is in the range of 20-35%, the melt index (Melt Index, MI)of the injection molded body 2 at a test condition of 1.2KILOS/300° C. is higher than 30 g/10 min, and the flexural modulus is higher than 6 GPa. When the content of PGF 22 is in the range 40-50%, the melt index of the injection molded body 2 at a test condition of 5 kg/260° C. is above 50 g/10 min, and the flexural modulus is higher than 11 GPa. PGF 22 can be a high profile ratio glass fiber (flat glass fiber). The amount of aromatic polycarbonate 21 is 30-50 wt %. The amount of profiled glass fiber 22 is 20-50 wt %. The amount of the flame retardant 23 is 9-15 wt %. The amount of the functional additive 24 is 1-9 wt %. Thereby, a novel injection molded body can be achieved.

The above aromatic polycarbonate 21 can be a thermoplastic resin, and also be selected from composition including two ingredients of aromatic polycarbonate/acrylonitrile butadiene styrene (ABS).

The above profiled glass fiber 22 has a profile ratio between 1.5-6 and an aspect ratio between 15-300. Alternatively, the profiled glass fiber can mixed with at least one of low aspect ratio filling materials such as glass powders, calcium silicates, calcium carbonates, nano clays, nano- silicon, talc etc.

The flame retardant 23 is a phosphorus flame retardant, and can be selected from organic phosphates and/or organic compounds containing a phosphorus-nitrogen bonding, such as aromatic phosphates of (GO)3P=0, wherein each G is independently alkyl, cycloalkyl, aryl, alkyl aryl or aralkyl. Two of the G groups can be linked together to provide a ring group such as di-phosphoric acid diphenyl pentaerythritol. In addition, other suitable aromatic phosphates can be diphenyl pentaerythritol diphosphate, phenyl di-(dodecyl) phosphate, phenyl di-(neopentyl) phosphate, phenyl bis-(3,5,5′-ethylhexyl) phosphate, ethyl diphenyl phosphate, 2-ethylhexyl bis-(p-tolyl) phosphate, bis-(2-ethyl hexyl) toluene phosphate, mesitylene phosphate, bis-(2-ethylhexyl) phenyl phosphate, tris (nonyl phenyl) phosphate, di-(dodecyl) toluene phosphate, dibutyl phenyl phosphate, 2-chloro-ethyl diphenyl phosphate tolyl, bis-(2,5,5′-trimethyl-hexyl) phosphate, and 2-chloroethyl hexyl diphenyl phosphate etc.

.THE above flame retardant 23 can be also inorganic flame retardants, and selected from potassium perfluorobutane sulfonate (potassium nonafluoro-1-butane-sulfonates, or referred to as Rimar salts) or sulfonic acids such as potassium diphenyl sulfonate.

The functional additive 24 can contain a composition of at least one selected from siloxane coupling agents, polyethylene terephthalate (PET), acrylonitrile styrene (AS), acrylonitrile-EPDM rubber-styrene copolymer (Acrylonitrile Ethylenepropylene Styrene, AES), styrene acrylonitrile silicone (SAS), acrylonitrile styrene acrylate (ASA), polyvinylidene fluoride or poly-vinylidene difluoride (PVDF), and polytetrafluoroethylene (PTFE). The siloxane coupling agents contain different functional groups of hydroxyl, epoxy, carboxyl and amino etc.

In the above embodiment, the injection molded body further includes a dispersing auxiliary. The dispersing auxiliary includes aliphatic wax or phosphorus compounds and can be selected from organic phosphorus compounds of phosphate compounds, phosphite compounds and phosphinate compounds.

In one preferred embodiment, the above-mentioned injection molded body 2 contains 38 wt % of aromatic polycarbonate 21 and 45 wt % of profiled glass fiber 22 as main raw materials, in combination with 12 wt % of the flame retardant 23 and 5 wt % of the functional additive 24 by means of a conventional manufacturing process. When in application, after the cavity 12 is formed by joining the male mold 10 and female mold 11, the aforementioned mixture for preparing the injection molded body 2 is injected from the injecting port 101 under pressure, so that the injection molded body 2 has the shape of the cavity 12. Then, the molds are unfolded to remove the molded body. Aromatic polycarbonate 21, profiled glass fiber 22, fire retardant 23 and functional additive 24 in the injection molded body 2 contribute to reduce floating fibers and grant qualities of low warpage and high stiffness through molding. The profiled glass fiber in the injection molded body 22 is a material of high profile ratio glass fiber (flat glass fiber) and having high profile ratio between 1.5-6, and high aspect ratio between 15-300. It is found that the injection molded body 2 has good uniformity, low warpage and high stiffness. Therefore, with the use of aromatic polycarbonate and profiled glass fiber as main raw materials for the injection molded body, the melt index (MI) of the injection molded body 2 is above 30 g/10 min and the flexural modulus thereof is above 6 GPa at the test condition of 1.2 kg/300° C., when the amount of profiled glass fiber 22 is between 20 and 35%. When the amount of profiled glass fiber 22 is between 40 and 50%, the melt index of the injection molded body 2 is above 50 g/10 min and the flexural modulus thereof is above 11 GPa at the test condition of 5 kg/260° C. That proves the injection molded body 2 can be applied to the use of thin-walled injection molding processing.

In summary, one embodiment offers an injection molded body which effectively improves the shortcomings in the prior art and grants the injection molded body, by using aromatic polycarbonate and profiled glass fiber as the main raw materials, with high melt index (Melt Index, MI) of above 30 g/10 min and high flexural modulus of above 6 GPa in the case of low glass fiber proportion (20-35%), and with high Melting Index value of above 50 g/10 min and high flexural modulus of above 11 GPa in the case of high glass fiber proportion (40-50%). Such a process can be applied to the use of injection molding processing for tablets, netbooks or ultra-thin laptops. The injection moldings after injection processing achieve less floating fibers and have the effects of low warpage and high stiffness, which makes this invention more progress, and more practical in use and therefore complies with the patent law.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. An injection molded body comprising a mixture of aromatic polycarbonate, profiled glass fiber (PGF), a flame retardant and a composition of at least one selected from siloxane coupling agents, polyethylene terephthalate (PET), acrylonitrile styrene (AS), acrylonitrile-EPDM rubber-styrene copolymer (Acrylonitrile Ethylenepropylene Styrene, AES), styrene acrylonitrile silicone (SAS), acrylonitrile styrene acrylate (ASA), polyvinylidene fluoride or poly-vinylidene difluoride (PVDF), and polytetrafluoroethylene (PTFE).

2. The injection molded body of claim 1, wherein a flexural modulus of the injection molded body is higher than 11 GPa and a melt index of the injection molded body is above 50 g/10 min.

3. The injection molded body of claim 1, wherein the aromatic polycarbonate is a thermoplastic resin and is selected from a composition including aromatic polycarbonate/acrylonitrile butadiene styrene (ABS).

4. The injection molded body of claim 1, further comprising siloxane coupling agents and wherein the siloxane coupling agents comprise different functional groups of hydroxyl, epoxy, carboxyl, and amino.

5. The injection molded body of claim 1, wherein the profiled glass fiber has a profile ratio between 1.5-6 and an aspect ratio between 15-300 and is mixed with at least one of low aspect ratio filling materials of glass powders, calcium silicates, calcium carbonates, nano clays, nano-silicon, and talc.

6. The injection molded body of claim 1, wherein the fire retardant is a phosphorus flame retardant and is selected from organic phosphates and/or organic compounds containing a phosphorus-nitrogen bonding.

7. The injection molded body of claim 1, wherein the flame retardant is one or more aromatic phosphates selected from the group consisting of diphenyl pentaerythritol diphosphate, phenyl di-(dodecyl) phosphate, phenyl di-(neopentyl) phosphate, phenyl bis-(3,5,5′-ethylhexyl) phosphate, ethyl diphenyl phosphate, 2-ethylhexyl bis-(p-tolyl) phosphate, bis-(2-ethyl hexyl) toluene phosphate, mesitylene phosphate, bis-(2-ethylhexyl) phenyl phosphate, tris (nonyl phenyl) phosphate, di-(dodecyl) toluene phosphate, dibutyl phenyl phosphate, 2-chloro-ethyl diphenyl phosphate tolyl, bis-(2,5,5′-trimethyl-hexyl) phosphate, and 2-chloroethyl hexyl diphenyl phosphate.

8. The injection molded body of claim 1, wherein the flame retardant is one or more inorganic flame retardants selected from the group consisting of potassium perfluorobutane sulfonate (potassium nonafluoro-1-butane-sulfonates, or referred to as Rimar salts) and sulfonic acids including potassium diphenyl sulfonate.

9. The injection molded body of claim 1, wherein the injection molded body further comprises a dispersing auxiliary which includes one or more of aliphatic wax and phosphorus compounds is selected from the group consisting of organic phosphorus compounds of phosphate compounds, phosphite compounds, and phosphinate.

10. The injection molded body of claim 1, wherein an amount of the aromatic polycarbonate is 30-50 wt %; an amount of the profiled glass fiber is 20-50 wt %; an amount of the flame retardant is 9-15 wt %; and an amount of the composition of at least one selected from siloxane coupling agents, polyethylene terephthalate (PET), acrylonitrile styrene (AS), acrylonitrile-EPDM rubber-styrene copolymer (Acrylonitrile Ethylenepropylene Styrene, AES), styrene acrylonitrile silicone (SAS), acrylonitrile styrene acrylate (ASA), polyvinylidene fluoride or poly-vinylidene difluoride (PVDF), and polytetrafluoroethylene (PTFE) is 1-9 wt %.

11. The injection molded body of claim 10, wherein when the amount of the profiled glass fiber in the injection molded body is in the range of 20-35%, a Melting Index value of the injection molded body is above 30 g/10 min and a flexural modulus is above 6 GPa.

12. The injection molded body of claim 10, wherein when the amount of the profiled glass fiber in the injection molded body is in the range of 40-50%, a Melting Index value of the injection molded body is above 50 g/10 min and a flexural modulus is above 11 GPa.
